(19) United States
(12) Patent Application Publication
(10) Pub. No.: US 2005/0226136 A1
(43) Pub. Date: Oct. 13, 2005

(54) Magnetooptic recording medium and method for producing the same

(75) Inventors: Mineo Moribe, Kawasaki (JP); Takahiro Umada, Kawasaki (JP); Keiji Shono, Kawasaki (JP)

Correspondence Address: Patrick G. Burns, Esq.;GREER, BURNS & CRAIN, LTD., Suite 2500, 300 South Wacker Dr., Chicago, IL, 60606, US

(73) Assignee: FUJITSU LIMITED

(21) Appl. No.: 11/126,090

(22) Filed: May 10, 2005

Related U.S. Application Data
(63) Continuation of application No. PCT/JP03/03896, filed on Mar. 27, 2003.

(30) Foreign Application Priority Data
Dec. 24, 2002 (JP) 2002-371784

(51) Int. Cl. G11B 7/24

(52) U.S. Cl. 369/275.4

(57) ABSTRACT

A magneto-optical recording medium (D1) includes a soft magnetic layer (2) and a magneto-optical recording layer (3) laminated sequentially onto a substrate (1) and is provided with a plurality of grooves (G) and lands (L). The product of the saturation magnetic flux density and thickness of the soft magnetic layer (2) is made different for the respective grooves (G) and lands (L). Thus, with respect to each groove (G) and each land (L), the magnetic focusing effect can be enhanced for one of these with a greater product of saturation magnetic flux density and thickness of the soft magnetic layer (2), while the effect can be weakened for the other one with a smaller product of saturation magnetic flux density and thickness of the soft magnetic layer. This enables the incidence of cross-writing to be suppressed.

### TECHNICAL FIELD

The present invention relates to a data rewritable magneto-optical recording medium and a method for producing the same.

### BACKGROUND ART

An example of a data recording method for a magneto-optical recording medium is the magnetic field modulation method. When recording data using the magnetic field modulation method, a laser beam is irradiated onto the recording target section of the magneto-optical recording medium and the magnetic field corresponding to the data is applied. When using this method, the magneto-optical recording medium should preferably have a structure which enables the magnetic field to be used efficiently.

A magneto-optical recording medium having a soft magnetic layer is ideal for the magnetic field modulation method. Such a magneto-optical recording medium is described, for example, in Japanese Patent Application Laid-open No. H03-137837. The magneto-optical recording medium of this patent application has a structure wherein a soft magnetic layer, a light curing resin layer, a magneto-optical recording layer and a protective layer are laminated sequentially onto a substrate. The surface of the light curing resin layer has a convex-concave shape, where a plurality of grooves and a plurality of lands are provided alternately side by side.

In the conventional magneto-optical recording medium, a magnetic field generated by a magnetic head, which is positioned facing the protective layer, extends through the protective layer, the magneto-optical recording layer and the light curing resin layer. Then, the magnetic field is moved through the soft magnetic layer in a direction parallel to this layer, and is again passed through the light curing resin layer, the magneto-optical recording layer and the protective layer to return to the magnetic head. Moving the magnetic field around in such a closed loop enables the magnetic field to act efficiently on the recording target section, which is ideal for recording data.

However, in the above-mentioned conventional technology, the lands are located to either side of the grooves. When, for example, a laser beam is irradiated onto the grooves with the aim of writing data onto the same, the laser beam may also be irradiated onto the lands. On the other hand, the soft magnetic layer has the same thickness for both the grooves and lands, where the magnetic field applied to the grooves may also act efficiently on the lands. This at times results in cross-writing whereby data is mistakenly written onto the lands when writing data onto the grooves. This type of cross-writing particularly becomes more evident as the track pitch of the magneto-optical recording medium, which is designed to increase the data recording capacity, becomes smaller.

### DISCLOSURE OF THE INVENTION

An object of the present invention is to provide a magneto-optical recording medium and a method for producing the same which is capable of solving or alleviating the above-mentioned problem.

The magneto-optical recording medium as provided by the first aspect of the present invention is a magneto-optical recording medium comprising a soft magnetic layer and a magneto-optical recording layer which are laminated sequentially onto a substrate, and the recording medium is provided with a plurality of grooves and a plurality of lands. The product of the saturation magnetic flux density and the thickness of the soft magnetic layer is different for each groove and each land.

The thickness of the soft magnetic layer may preferably be different for the respective grooves and lands.

The material of the soft magnetic layer may preferably be the same for each of the grooves and the lands.

Each of the grooves may preferably be a data recording target section, where the thickness of the soft magnetic layer for each of the grooves is greater than that for each of the lands.

Each of the lands may preferably be a data recording target section, where the thickness of the soft magnetic layer for each of the lands is greater than that for each of the grooves.

The method for manufacturing a magneto-optical recording medium as provided by the second aspect of the present invention comprises: a first step of manufacturing a substrate with a surface on which a plurality of pre-grooves are formed; a second step of forming a soft magnetic layer on the surface of the substrate; and a third step of forming a magneto-optical recording layer on the soft magnetic layer and providing a plurality of grooves and a plurality of lands. In the second step of the above method, a soft magnetic material film is formed on the surface of the substrate to a thickness greater than depths of the pre-grooves, and the soft magnetic material film is subjected to etching to be varied in thickness at sections corresponding to each groove and each land.

The formation of the soft magnetic material film may preferably be performed by sputtering and the etching process of the soft magnetic material film may preferably be performed by dry etching.

The manufacturing method of the magneto-optical recording medium as provided by the third aspect of the present invention comprises: a first step of forming a substrate; a second step of forming a soft magnetic layer on the substrate; and a third step of forming a magneto-optical recording layer on the soft magnetic layer for providing a plurality of grooves and a plurality of lands. In the method, a mold member having an indented-and-raised surface is used to form, on the surface of the mold member, a soft magnetic layer with a different thickness at the indented and the raised sections of the mold member, and then the soft magnetic layer is transcribed onto the substrate via a resin layer.

The soft magnetic layer may preferably be produced by forming, on the surface of the mold member, a soft magnetic material film having a thickness greater than the surface gap of the mold, and then the soft magnetic material film is subjected to etching.

The formation of the soft magnetic material film may preferably be performed by sputtering and the etching of the soft magnetic material film may preferably be performed by dry etching.

Easy release treatment may preferably be performed on the surface of the mold member prior to forming the soft magnetic material film on the surface of the mold member.

Other features and advantages of the present invention become clearer from the detailed description of the embodiments of the present invention below.

### BRIEF DESCRIPTION OF THE DRAWINGS

FIG. 1 is a cross section showing an example of a magneto-optical recording medium concerning the present invention;

FIGS. 2A and 2B are cross sections describing the step of the method of manufacturing a magneto-optical recording medium as shown in FIG. 1;

FIG. 3 is a graph showing the results of tests as carried out by the inventors of the present invention;

FIG. 4 is a cross section showing another example of a magneto-optical recording medium concerning the present invention;

FIGS. 5A to 5C are cross sections describing the step of the method of manufacturing a magneto-optical recording medium as shown in FIG. 4; and

FIGS. 6A and 6B are cross sections describing the step of the method of manufacturing a magneto-optical recording medium as shown in FIG. 4.

### BEST MODE FOR CARRYING OUT THE INVENTION

The preferred embodiment of the present invention is described below with reference to the accompanying drawings.

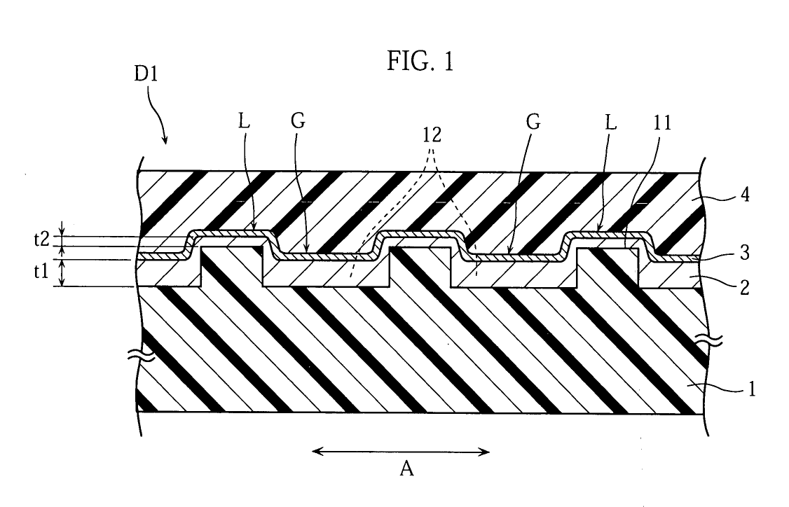

FIG. 1 shows an embodiment of the magneto-optical recording medium concerning the present invention. The magneto-optical disc D1 of the present embodiment has a structure wherein a soft magnetic layer 2, a magneto-optical recording layer 3 and a protective layer 4 are respectively laminated in sequence on the upper surface 11 of a substrate 1.

The substrate 1 is made, for example, of polycarbonate and has a circular doughnut shape. A plurality of pre-grooves 12 which extend in a circumferential direction are formed on the upper surface 11 of the substrate 1 at spaced intervals in a radial direction A. This enables a structure wherein a plurality of grooves G and lands L are provided alternately side by side. Each of the grooves G include a part of the soft magnetic layer 2 and a part of the magneto-optical recording layer 3 which are laminated onto the bottom surface of the pre-grooves 12. In this magneto-optical disc D1, these grooves G are tracks for recording data. Each of the lands L also include a part of the soft magnetic layer 2 and a part of the magneto-optical recording layer 3. However, these lands L are not tracks for recording data. The thickness of the substrate 1 is, for example, 1.2 mm. The width and the depth of each of the pre-grooves 12 are, for example, 0.18 μm and 120 nm respectively. The pitch of the pre-grooves 12 is, for example, 0.27 μm.

The soft magnetic layer 2 is, for example, made of an FeC high permeability material, the saturation magnetic flux density Bs of which is, for example, 2T. The direction of magnetization of the soft magnetic layer 2 is parallel to this layer, where the soft magnetic layer 2 aids in enabling the magnetic field generated by the magnetic head to act efficiently on the recording target section of the magneto-optical recording layer 3. The thickness of the soft magnetic layer 2 differs at the grooves G and the lands L. If the thickness t1 of the soft magnetic layer 2 of the grooves G was, for example, 100 nm, the thickness t2 of the soft magnetic layer 2 of the lands L would be, for example, 20 nm.

The magneto-optical recording layer 3 is the section which records data and has a magnetic coercive force. This magneto-optical recording layer 3 has a multi-layered structure wherein layers such as a dielectric layer or a reflecting layer are combined with a perpendicular magnetization layer in which the direction of magnetization is perpendicular to the layer. For example, these may consist of an AgPdCuSi layer, a SiN layer, a AgPdCuSi layer, a GdFeCo layer, a TbFeCo layer and a SiN layer. Such multi-layered structures are ideal for suitably recording and replaying data. The thickness of the magneto-optical recording layer 3 is, for example, 125 nm. This thickness is, for example, broken down as follows: an AgPdCuSi layer of 10 nm; a SiN layer of 5 nm; an AgPdCuSi layer of 30 nm; a GdFeCo layer of 5 nm; a TbFeCo layer of 25 nm; and a SiN layer of 50 nm.

The protective layer 4 is a section for protecting the magneto-optical recording layer 3 and is, for example, made of a transparent ultraviolet curing resin. The thickness of this protective layer 4 is, for example, 15 μm.

Next, an example of the method for manufacturing a magneto-optical disc D1 is described.

First, the substrate 1 is formed using a resin by means of injection molding. A nickel stamper, for example, is used in this process. Specified convex-concave patterns which correspond to the shape of the upper surface 11 of the substrate 1 are formed on the surface of the stamper. A cavity consistent with the shape of the substrate 1 is formed by attaching the stamper to the mold. This cavity is filled with molten polycarbonate which is then cured to form the substrate 1.

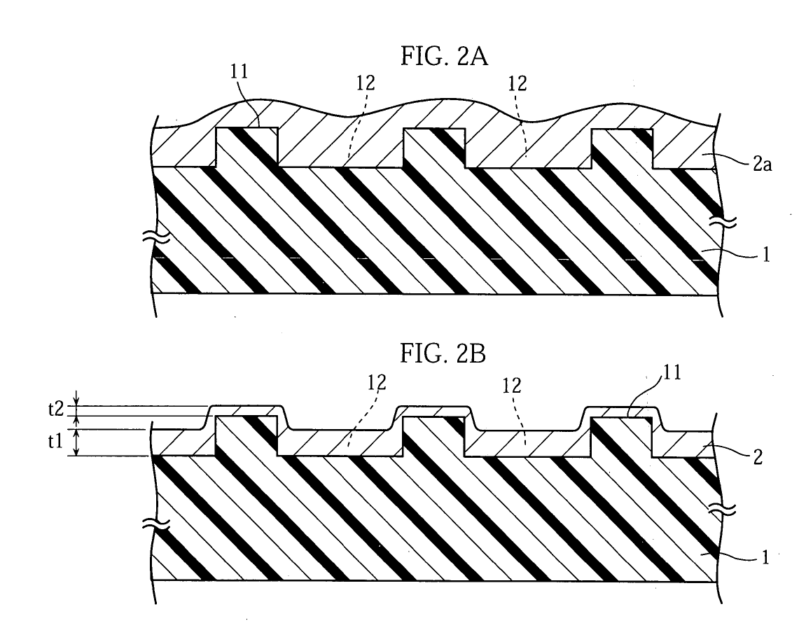

Next, the soft magnetic layer 2 is formed on the substrate 1. During this process, a soft magnetic material film 2a with a thickness to completely cover the pre-grooves 12 as shown in FIG. 2A is formed on the upper surface 11 of the substrate 1 by means of, for example, sputtering. The surface of the soft magnetic material film 2a assumes substantially a wave shape due to the convex-concave shape of the upper surface 11 of the substrate 1 on which the plurality of pre-grooves 12 are formed. The thickness of the soft magnetic material film 2a at each of the pre-grooves 12 becomes greater than that at other sections of the soft magnetic material film 2a. This is followed by, for example, an etching process which is carried out wherein argon ions are collided against the surface of the soft magnetic material film 2a at a gas pressure of 1.5 Pa and an RF electricity of 0.5 kW. This etching process enables the formation of the soft magnetic layer 2 as shown in FIG. 2B. According to the etching process, the soft magnetic material film 2a can be cut roughly uniformly in various places in the direction of thickness of the same. The thickness of the section of the soft magnetic layer 2 which corresponds to each of the grooves G is therefore greater than that which corresponds to each of the lands L.

Next, the magneto-optical recording layer 3 and the protective layer 4 are formed in sequence. The magneto-optical recording layer 3 can be formed by sequentially laminating the plurality of layers which make up the same onto the soft magnetic layer 2 by means of, for example, sputtering. The protective layer 4 can be formed by applying an uncured ultraviolet curing resin onto the magneto-optical recording layer 3 by means of, for example, a spin coat method. The ultraviolet curing resin is then cured by means of ultraviolet irradiation. The magneto-optical disc D1 is obtained by means of the series of steps.

Next, the operation of the magneto-optical disc D1 is described.

The thickness of the soft magnetic layer 2 differs at the grooves G and lands L, where the thickness t1 of the soft magnetic layer 2 of the grooves G which are data recording tracks is greater than the thickness t2 of the soft magnetic layer 2 of the lands L which are non-data recording tracks. On the other hand, since the material is the same over the entire area of the soft magnetic layer 2, the saturation magnetic flux density of the soft magnetic layer remains the same in each area. Accordingly, the product of the saturation magnetic flux density and the thickness of the soft magnetic layer 2 is greater at the grooves G than at the lands L. Thus, more magnetic fields are able to pass through the soft magnetic layer 2 of the grooves G than the soft magnetic layer 2 of the lands L. The magnetic focusing effect of the magnetic field can be enhanced for the grooves G, whereas the effect can be reduced for the lands L. Thus, data can be recorded suitably to the grooves G when recording data to the grooves G of the magneto-optical disc D1 by means of, for example, the magnetic field modulation method. On the other hand, recording data to the lands L becomes difficult. This results in a reduced incidence of cross-writing, in which data is mistakenly recorded to the lands L, or the non-data recording tracks. This reduction in the incidence of cross-writing enables a smaller track pitch, which is ideal for maximizing the capacity for the magneto-optical disc D1.

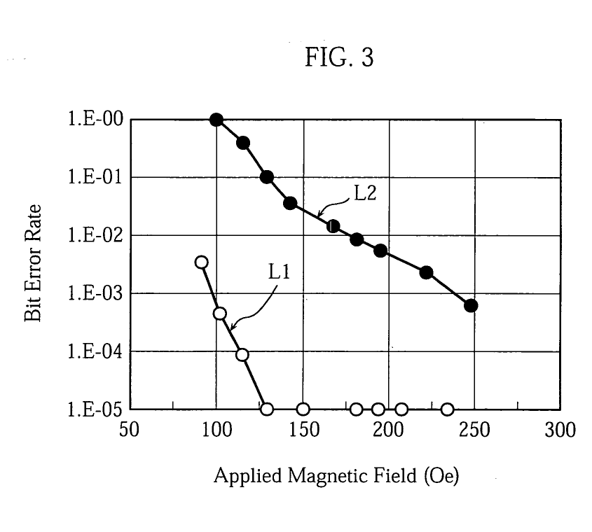

The inventors of the present invention proceeded to write a recording mark with a mark length of 0.15 μm onto magneto-optical disc grooves and lands having the same structure as the magneto-optical disc D1 using an optical head with an objective lens numerical aperture of 0.85 and a laser wavelength of 405 nm in order to carry out tests to investigate respective bit error rates. The results obtained from the tests are shown in FIG. 3. In this figure, the polygonal line L1 shows the results for cases where a recording mark was written onto the grooves, and the polygonal line L2 shows results for cases where a recording mark was written onto the lands. These test results show that, in any of the cases where the applied magnetic field was 80-230 (Oe), data is more properly recordable onto the grooves than onto the lands. These test results also suggest that the above-mentioned effect can be obtained for the magneto-optical disc D1.

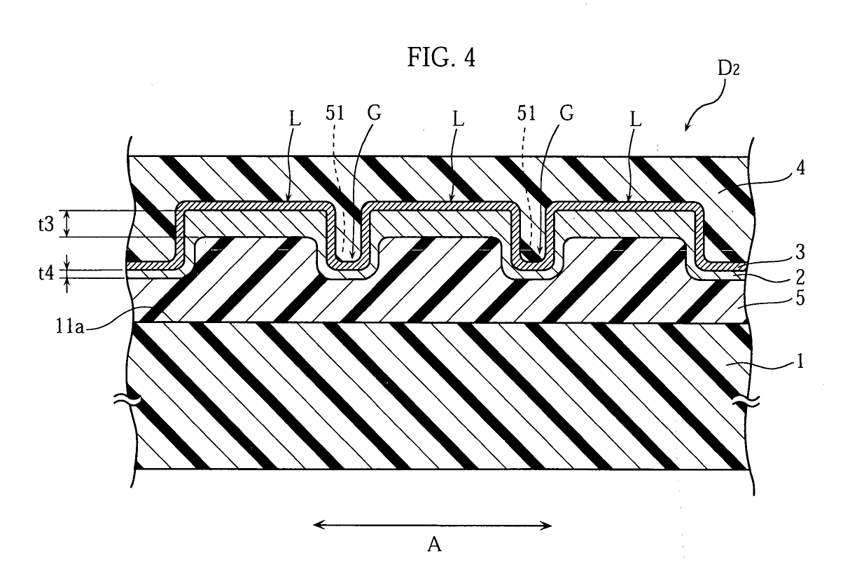

FIG. 4 shows another embodiment of the magneto-optical recording medium concerning the present invention. The symbols in FIG. 4 are the same for members which are the same as or are similar to those of the above-mentioned embodiment.

The magneto-optical disc D2 of the present embodiment differs from the above embodiment in that the lands L are data recording tracks. This magneto-optical disc D2 has a structure wherein a resin layer 5, a soft magnetic layer 2, a magneto-optical recording layer 3 and a protective layer 4 are laminated sequentially onto the substrate 1.

The upper surface 11a of the substrate 1 differs from the upper surface 11 of the substrate 1 of the magneto-optical disc D1 in that it is flat-shaped. The resin layer 5 is made of, for example, an ultraviolet curing resin, the upper surface of which have a plurality of pre-grooves 51 for the formation of grooves G and lands L. The thickness t3 of the soft magnetic layer 2 of the lands L is, for example, 100 nm, and the thickness t4 of the soft magnetic layer 2 of the grooves G is, for example, 70 nm. In contrast to the magneto-optical disc D1, the thickness t3 of the soft magnetic layer 2 of the lands L is greater than the thickness t4 of the soft magnetic layer 2 of the grooves G in the magneto-optical disc D2.

Next, an example of the method of manufacturing the magneto-optical disc D2 is described.

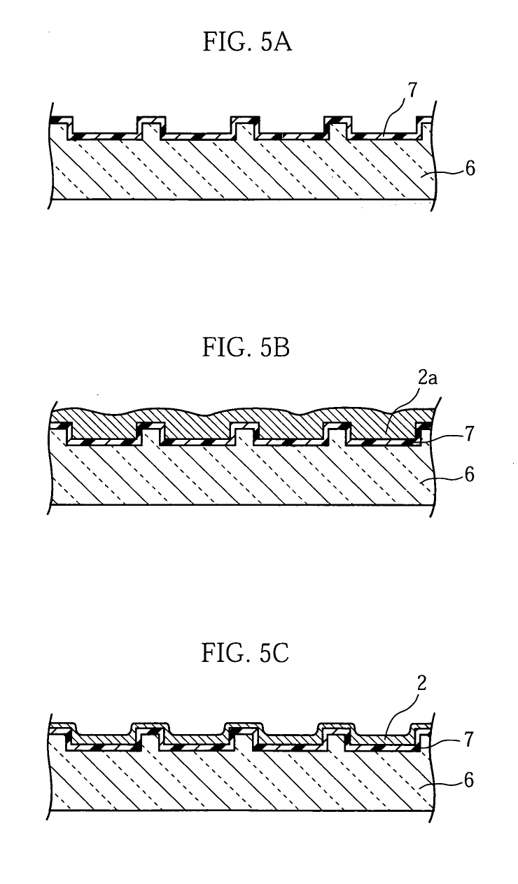

First, the substrate 1 is formed using resin by means of the injection molding method. Meanwhile, as shown in FIG. 5A, a transparent glass stamper 6 having specific convex-concave patterns which correspond to the grooves G and lands L is manufactured separately to the above process. A silicone resin layer 7 is formed on the surface of the transparent stamper 6. This process, as described below, is to allow for easier removal of the transparent stamper 6 from the soft magnetic layer 2 following the adhesion of the substrate 1 and the soft magnetic layer 2 via the resin layer 5.

Next, as shown in FIG. 5B, a soft magnetic material film 2a is formed on the silicone resin layer 7. This is then subjected to an etching process to obtain a soft magnetic layer 2 as shown in FIG. 5C. This process is the same as that for the formation of the soft magnetic layer 2 as described in the method of manufacturing the magneto-optical disc D1. Here, the soft magnetic material film 2a is formed by means of, for example, sputtering. The etching process is carried out by, for example, colliding argon ions onto the surface of the soft magnetic material film 2a. Based on the same principle as described with reference to FIGS. 2A and 2B, this results in a soft magnetic layer 2 thickness which is greater at the section above the concave section of the transparent stamper 6 than at the section above the convex section of the same.

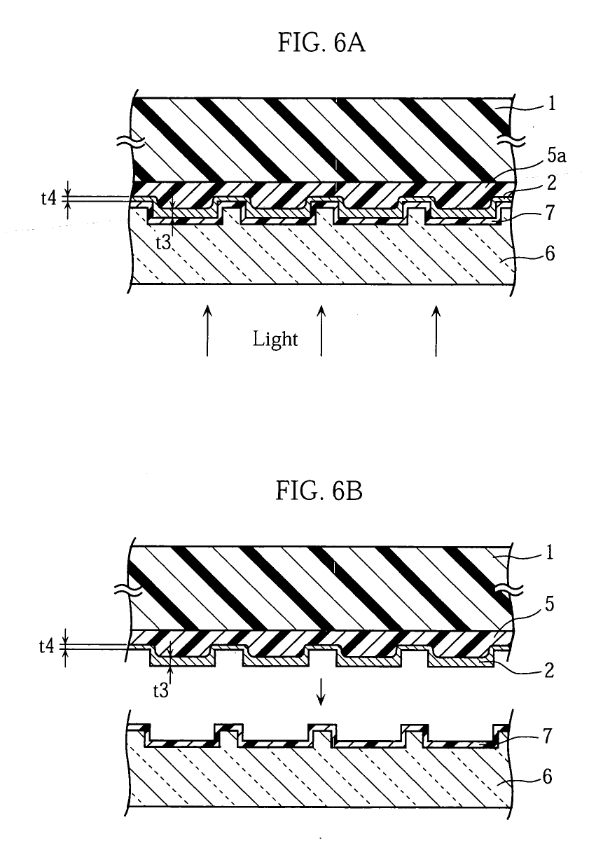

Next, the soft magnetic layer 2 is transcribed onto the substrate 1. In this process, as shown in FIG. 6A, an uncured ultraviolet curing resin 5a is applied to the soft magnetic layer 2 so that the thickness is greater than the gap between the concave and convex sections of the soft magnetic layer 2. Furthermore, the substrate 1, the resin layer 5 and the soft magnetic layer 2 in FIGS. 6A and 6B are illustrated in reverse to those as shown in FIG. 4. The substrate 1 is then positioned on an ultraviolet curing resin 5a. Ultraviolet rays are then irradiated in a direction from the transparent stamper 6 to the ultraviolet curing resin 5a to cure the ultraviolet curing resin 5a. This not only enables the formation of the resin layer 5, but also enables the adhesion of the soft magnetic layer 2 and the substrate 1 to the resin layer 5. The transparent stamper 6 and the silicone resin layer 7 are then separated from the soft magnetic layer 2 as shown in FIG. 6B. With these processes, the soft magnetic layer 2 is transcribed onto the resin layer 5. The magneto-optical recording layer 3 and the protective layer 4 are then formed on the soft magnetic layer 2 using the same method as in the above-mentioned embodiment. The magneto-optical disc D2 is obtained by means of the above series of steps.

According to the above-mentioned method of manufacture, a magneto-optical disc D2 in which the thickness t3 of the soft magnetic layer 2 of the lands L is greater than the thickness t4 of the soft magnetic layer 2 of the grooves G can be readily obtained.

As opposed to the magneto-optical disc D1, in the magneto-optical disc D2, the product of the saturation magnetic flux density and the thickness of the soft magnetic layer 2 is greater for the lands L than for the grooves G. This means that the applied magnetic field acts more efficiently on the lands L than on the grooves G. Thus, the magneto-optical disc D2 is ideal for recording data onto lands L, where any mistaken recording onto the grooves G becomes difficult. As with the magneto-optical disc D1, this suppresses the incidence of cross-writing.

The present invention is in no way limited to the above-mentioned embodiment. The structures of the respective sections of the magneto-optical recording medium concerning the present invention can be subject to various design changes. Similarly, the respective steps in the method of manufacturing the magneto-optical recording medium concerning the present invention can also be subject to various changes.

For example, the material used for the soft magnetic layer does not have to be of a FeC high permeability material, and may be of another high permeability material such as a FeCoNi alloy. Similarly, the method of forming the soft magnetic layer is not limited to combined methods of sputtering and etching processes, and may comprise a method in which an etching process is carried out following the formation of a soft magnetic material film on the substrate using, for example, an electroless plating method.

As a means of varying the product of the saturation magnetic flux density and thickness of the respective soft magnetic layers of the grooves and lands, a means of varying the saturation magnetic flux density can also be used instead of varying the thickness. More concretely, a structure may be used wherein the product of the saturation magnetic flux density and the thickness of the soft magnetic layer is varied by using material with differing saturation magnetic flux densities for the soft magnetic layer of the grooves and lands. A form of varying the respective thicknesses of the soft magnetic layer of the grooves and lands includes setting the thickness of the soft magnetic layer of either the grooves or lands to zero, or namely, having a structure wherein either the grooves or lands is not present.

The magneto-optical recording medium of the present invention is by no means limited to a so-called single-faced recording structure in which a magneto-optical recording layer is positioned only on one side of the substrate, and may also consist of a so-called double-faced recording structure in which a magneto-optical recording layer is positioned on both sides of the substrate. This type of structure enables a maximization of capacity. The substrate is not limited to one made of resin, and may also be made of, for example, glass or aluminium. Similarly, the method of forming the substrate is not limited to the injection molding method, and may consist of the so-called 2P (photo-polymer) method in which the substrate is formed using an ultraviolet curing resin.

1. A magneto-optical recording medium comprising a soft magnetic layer and a magneto-optical recording layer laminated sequentially onto a substrate, the medium being provided with a plurality of grooves and a plurality of lands,
wherein the product of a saturation magnetic flux density and a thickness of the soft magnetic layer is different for each groove and each land.

2. The magneto-optical recording medium according to claim 1, wherein the thickness of the soft magnetic layer is different for each groove and each land.

3. The magneto-optical recording medium according to claim 2, wherein the soft magnetic layer is made of a same material for each groove and each land.

4. The magneto-optical recording medium according to claim 3, wherein each groove is a data recording target section, and the thickness of the soft magnetic layer is greater for each groove than for each land.

5. The magneto-optical recording medium according to claim 3, wherein each land is a data recording target section, and the thickness of the soft magnetic layer is greater for each land than for each groove.

6. A method for manufacturing a magneto-optical recording medium, the method comprising: a first step of manufacturing a substrate with a surface on which a plurality of pre-grooves are formed; a second step of forming a soft magnetic layer on the surface of the substrate; and a third step of forming a magneto-optical recording layer on the soft magnetic layer for providing a plurality of grooves and a plurality of lands,
wherein, in the second step, a soft magnetic material film is formed on the surface of the substrate to a thickness greater than depths of the pre-grooves, and the soft magnetic material film is subjected to etching to be varied in thickness at sections corresponding to each groove and each land.

7. The method for manufacturing a magneto-optical recording medium according to claim 6, wherein the formation of the soft magnetic material film is performed by sputtering and the etching of the soft magnetic material film is performed by dry etching.

8. A method for manufacturing a magneto-optical recording medium, the method comprising: a first step of forming a substrate; a second step of forming a soft magnetic layer on the substrate; and a third step of forming a magneto-optical recording layer on the soft magnetic layer for providing a plurality of grooves and a plurality of lands,
wherein, in the second step, a mold member having an indented and raised surface is used to form, on the surface of the mold member, a soft magnetic layer with a different thickness at indented and raised sections of the mold member, and the soft magnetic layer is transcribed onto the substrate via a resin layer.

9. The method for manufacturing a magneto-optical recording medium according to claim 8, wherein the soft magnetic layer is produced by forming, on the surface of the mold member, a soft magnetic material film having a thickness greater than a surface gap of the mold member, and the soft magnetic material film is subjected to etching.

10. The method for manufacturing a magneto-optical recording medium according to claim 9, wherein the formation of the soft magnetic material film is performed by sputtering and the etching of the soft magnetic material film is performed by dry etching.

11. The method for manufacturing a magneto-optical recording medium according to claim 9, wherein the surface of the mold member is subjected to easy release treatment prior to forming the soft magnetic material film on surface of the mold member.
